(19) United States
(12) Patent Application Publication
(10) Pub. No.: US 2025/0136159 A1
(43) Pub. Date: May 1, 2025

(54) MULTI-MODE SWITCHING SIMULATION TRAINING SYSTEM BASED ON REAL CTC SYSTEM

(71) Applicant: CASCO SIGNAL LTD., Jing'an District, Shanghai (CN)

(72) Inventors: Jinyu YUE, Jing'an District, Shanghai (CN); Guozhi ZHAO, Jing'an District, Shanghai (CN); Wei SHAN, Jing'an District, Shanghai (CN); Zhixin CHEN, Jing'an District, Shanghai (CN); Liang GUO, Jing'an District, Shanghai (CN); Yu FAN, Jing'an District, Shanghai (CN); Yuan GUO, Jing'an District, Shanghai (CN); Yan YAN, Jing'an District, Shanghai (CN)

(21) Appl. No.: 18/835,638

(22) PCT Filed: Nov. 9, 2022
(86) PCT No.: PCT/CN2022/130906

§ 371 Date: Aug. 2, 2024

(30) Foreign Application Priority Data
Jul. 8, 2022 (CN) 202210806154.4

(51) Int. Cl. B61L 27/60; B61L 27/04; G09B 5/06; G09B 7/04; G09B 9/02

(52) U.S. Cl. CPC B61L 27/60; B61L 27/04; G09B 5/06; G09B 7/04; G09B 9/02

(57) ABSTRACT

A multi-mode switching simulation training system based on a real centralized traffic control (CTC) system, including a center platform and a plurality of student platforms connected to the center platform through a network, where the center platform includes a first management module and a first training system connected to the first management module; each student platform includes a second management module and a second training system connected to the second management module; and the first management module is configured to control the start and stop of the first training system, and the second management module is configured to control the start and stop of the second training system, so as to switch a training mode of the multi-mode switching simulation system. The present invention can achieve the purposes of individual training for dispatchers, individual training for attendants, joint training for the dispatchers and the attendants, and skills competition.

### FIELD OF TECHNOLOGY

The present invention relates to the technical field of rail transit, in particular to a multi-mode switching simulation training system based on a real centralized traffic control (CTC) system.

### BACKGROUND

With the rapid development of high-speed railways, the rapid growth of operating mileage, the increase in line complexity, and the diversity and uncertainty of accidents have all put forward higher requirements for the rapid response of dispatchers and station attendants.

At present, the CTC system is an important infrastructure for a train operation organization and a guarantee for the safe and efficient operation of railway trains. Both center dispatchers and station attendants need to undergo corresponding CTC operation skill training.

In view of the training requirements of personnel from all parties, because the dispatchers are in a railway bureau center and the station attendants are in all stations, the current way is to build different simulation training systems in the railway bureau center and the stations to meet the requirements of all the parties. This way has the following problems:

It is a waste of resources to build a training system in the center and all the stations separately.

In the actual train operation, the dispatchers have more service interactions with the station attendants, but the current way cannot implement the functions of service interaction and joint training.

The railway bureau often holds skills competitions, and all the attendants can compete in the same environment, but the current way cannot implement the function of the skills competitions.

Therefore, a system capable of solving the above problems is needed, which can flexibly implement multi-mode switching, and achieve the purposes of individual training for dispatchers, individual training for attendants, joint training for the dispatchers and the attendants, and skills competition, thereby maximizing the utilization of equipment.

### SUMMARY

An objective of the present invention is to provide a multi-mode switching simulation training system based on a real CTC system, which can meet the requirements of individual training for dispatchers, individual training for attendants, joint training for the dispatchers and the attendants, and skills competition, and reduce the training cost.

To achieve the above objective, the present invention is implemented by the following technical solution:

A multi-mode switching simulation training system based on a real CTC system includes a center platform and a plurality of student platforms connected to the center platform through a network. The center platform includes a first management module and a first training system connected to the first management module. Each of the student platforms includes a second management module and a second training system connected to the second management module. The first management module is configured to control the start and stop of the first training system, and the second management module is configured to control the start and stop of the second training system, so as to switch a training mode of the multi-mode switching simulation system.

The first training system includes a first CTC service system, a first CTC dispatch system, and a first simulation system. The second training system includes a second CTC service system, a second CTC dispatch system, a CTC autonomous computer, a CTC train service terminal, and a second simulation system.

The training mode includes an individual training mode, a mixed individual and joint training mode, and a joint training mode.

The multi-mode switching simulation training system based on a real CTC system further includes an educational administration system, where the educational administration system includes a teacher computer disposed in the center platform and a plurality of student computers; and each of the student computers is disposed in a corresponding one of the student platforms, and the teacher computer is connected to the plurality of student computers through the network. The teacher computer is configured to manage an examination question scenario, send examination questions to a corresponding one of the student computers, and analyze and display an examination result of the examination questions fed back by the corresponding student computer.

The first simulation system is the same as the second simulation system and includes a trackside simulation system, a train control simulation system, and an interlocking simulation system.

When the training mode is the individual training mode, each of the student platforms is in an individual mode; and the first management module in the center platform controls the first training system to stop running, and the teacher computer is started to check a state of each student platform. The second management module in each student platform is configured to start the corresponding second training system based on a preset training requirement.

When the preset training requirement is to train a dispatcher, the second management module starts the second CTC dispatch system, the second CTC service system, the CTC autonomous computer, and the second simulation system, and the dispatcher undergoes dispatch training on a corresponding one of the student platforms.

When the preset training requirement is to train a station attendant, the second management module starts the second CTC service system, the CTC autonomous computer, the CTC train service terminal, and the second simulation system, and the station attendant undergoes station-related operation and training on a corresponding one of the student platforms.

When the preset training requirement is a skills competition for all station attendants, the second management modules of all the student platforms start the second CTC service systems, the CTC autonomous computers, and the CTC train service terminals, such that all the student platforms run a same station environment.

When the training mode is the joint training mode, all the student platforms are in a joint mode; the first management module in the center platform starts the teacher computer, the first CTC dispatch system, the first CTC service system, and the first simulation system; the second management modules in all the student platforms start the CTC autonomous computers and the CTC train service terminals; and the dispatcher and the station attendant are capable of calling the corresponding first CTC dispatch system, first CTC service system and first simulation system on the center platform from their respective student platforms for joint training.

When the training mode is the mixed individual and joint training mode, some of the plurality of student platforms are in the individual mode, while the rest of the student platforms are in the joint mode; the first management module of the center platform starts the first CTC dispatch system, the first CTC service system, and the first simulation system; the student platforms in the joint mode start the corresponding CTC autonomous computers and CTC train service terminals by their respective second management modules; the dispatcher and the station attendant call the corresponding first CTC dispatch system, first CTC service system and first simulation system on the center platform by the corresponding student platforms in the joint mode for joint training; the student platforms in the individual mode start the corresponding second CTC dispatch systems, second CTC service systems, CTC autonomous computers, CTC train service terminals, and second simulation systems by their respective second management modules; and the dispatcher and the station attendant undergo individual training by the corresponding student platforms in the individual mode.

The present invention has at least one of the following advantages:

The multi-mode switching simulation training system based on a real CTC system provided by the present invention provides a function of switching multiple training modes, and can simultaneously implement the functions of individual training for dispatchers, individual training for attendants, joint training for the dispatchers and the attendants, and skills competition.

According to the system scale of the multi-mode switching simulation training system based on a real CTC system provided by the present invention, the student platforms can be dynamically expanded as needed to implement the function of dynamically adding the student platforms by a user.

The multi-mode switching simulation training system based on a real CTC system provided by the present invention can be built on the basis of an existing training system for railway bureau. A training system is established in a railway bureau center and all stations separately. The multi-mode switching simulation training system can integrate all equipment into a training system by using hardware of the established training systems for the center and the stations. By means of mode switching, the purposes of training in the center, training at the stations, and joint training in the center and at the stations for users can be achieved, thereby increasing the utilization rate of the equipment, and maximizing the utilization of the equipment.

### BRIEF DESCRIPTION OF THE DRAWINGS

FIG. 1 is a structure block diagram of a multi-mode switching simulation training system based on a real CTC system provided by an embodiment of the present invention;

FIG. 2 is an overall arrangement block diagram of a multi-mode switching simulation training system based on a real CTC system provided by an embodiment of the present invention;

FIG. 3 is a block diagram in which all systems are in a startup state when all student platforms in a multi-mode switching simulation training system based on a real CTC system provided by an embodiment of the present invention are in an individual mode;

FIG. 4 is a block diagram in which all systems are in a startup state when some student platforms in a multi-mode switching simulation training system based on a real CTC system provided by an embodiment of the present invention are in a joint mode; and

FIG. 5 is a block diagram in which all systems are in a startup state when all student platforms in a multi-mode switching simulation training system based on a real CTC system provided by an embodiment of the present invention are in a joint mode.

### DETAILED DESCRIPTION OF THE EMBODIMENTS

The multi-mode switching simulation training system based on a real CTC system provided by the present invention is further described in detail below with reference to the accompanying drawings and the specific embodiments. The advantages and features of the present invention will become clearer from the following description. It should be noted that the drawings in a very simplified form and with an imprecise scale are only used to conveniently and clearly assist in describing the embodiments of the present invention. In order to make the objectives, features and advantages of the present invention more obvious and comprehensible, reference can be made to the accompanying drawings. It should be noted that the structures, proportions, sizes, etc. shown in the accompanying drawings of this specification are only used to match the content disclosed in the specification, for those skilled in the art to understand and read, and are not used to limit the limiting condition of implementation of the present invention, so there is no technical substantive meaning, and any modification of structure, change of proportional relationship or adjustment of size should still fall within the scope covered by the disclosed technical content of the present invention without affecting the effect and purpose of the present invention.

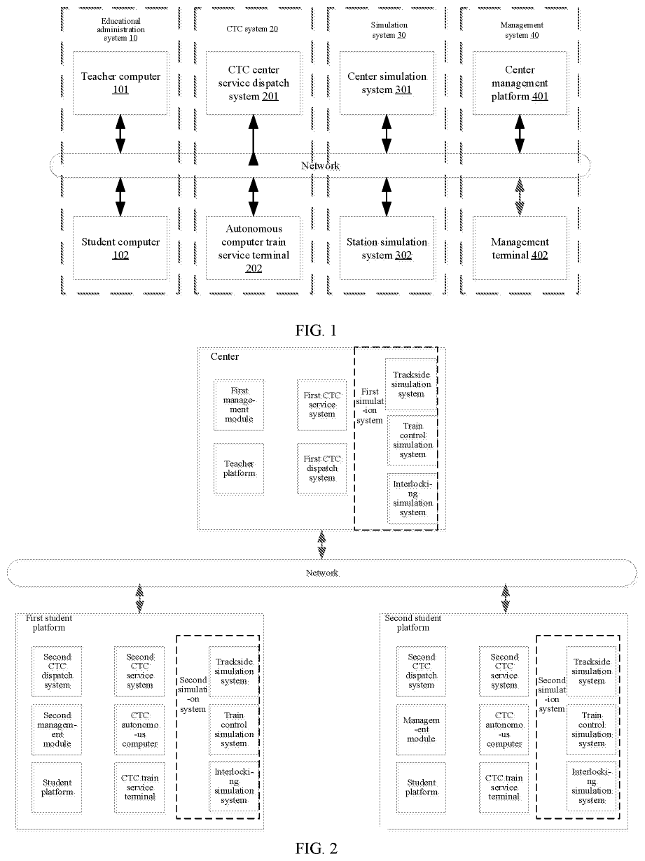

As shown in FIG. 1, the multi-mode switching simulation training system based on a real CTC system provided by this embodiment includes the following four parts: an educational administration system 10, a CTC system 20, a simulation system 30, and a management system 40. The educational administration system 10 includes a teacher computer 101 and a plurality of student computers 102 connected to the teacher computer 101 through a network. The teacher computer 101 is configured to manage an examination question scenario, send examination questions to the corresponding student computer 102, and analyze and display an examination result of the examination questions fed back by the corresponding student computer 102. The teacher computer 101 may be a teacher platform of a center platform in FIG. 2. The student computer 102 may be either a first student platform or a second student platform in FIG. 2.

The CTC system 20 is completely consistent with CTC systems actually used by various railway bureaus, thereby ensuring that an interface and an environment during training are completely consistent with those in the actual operation.

As shown in FIG. 1, the CTC system 20 includes a CTC center service dispatch system 201 disposed in the center platform. The CTC center service dispatch system 201 specifically refers to a first CTC service system and a first CTC dispatch system as shown in FIG. 2.

The CTC system 20 further includes an autonomous computer train service terminal 202 which may refer to a CTC autonomous computer and a CTC train service terminal disposed in the student platform as shown in FIG. 2.

The simulation system 30 simulates outdoor signal equipment, a computer interlocking system, a train control system, and an on-board system by means of software modeling and actual field data injection, and cooperates with the CTC system to jointly implement the main function of the simulation training system. The simulation system 30 includes a center simulation system 301 and a station simulation system 302. The center simulation system 301 may be a first simulation system disposed in the center platform as shown in FIG. 2.

The station simulation system 302 may be a second simulation system disposed in the student platform as shown in FIG. 2.

The educational administration system 10 is responsible for managing the examination question scenario, sending and automatically determining the examination questions, and analyzing and displaying the examination result. The management system 40 implements the start and stop of all software in the simulation training system, and switches between a center mode and an individual mode as needed, thereby ensuring that the requirements of scenarios of individual training for dispatch, individual training for stations, joint training for the dispatch and the stations, and competition can be met without personnel mobility.

The management system 40 includes a center management platform 401 and a management terminal 402. The center management platform 401 may be a first management module disposed in the center platform as shown in FIG. 2, and the management terminal 402 may be a second management module disposed in the student platform as shown in FIG. 2.

The multi-mode switching simulation training system based on a real CTC system provided by this embodiment can be individually networked and built, and is completely isolated from an actual service system in terms of network hardware and server hardware, thereby ensuring that the training process does not affect the actual service system. The simulation training system provided by this embodiment implements the function of multi-mode switching through the management system. The management system manages the start and stop of all the CTC systems and simulation systems. By starting different system software in the center and the student platforms, the training system can be configured to be in three different modes: all the student platforms are in an individual mode, some student platforms are in a joint mode, and all the student platforms are in the joint mode.

As shown in FIG. 2, an overall arrangement of the multi-mode switching simulation training system based on a real CTC system provided by this embodiment is as follows: the multi-mode switching simulation training system based on a real CTC system is generally divided into two parts: a center (a center platform) and student platforms; the center can be arranged in a railway bureau center or a district center; and a student platform is arranged in the center as needed, and a student platform is arranged at each station to form a distributed arrangement for training of dispatchers and station attendants. The center and each student platform can adopt a multi-machine arrangement according to requirements and budgets. Different system software runs in each machine.

The multi-mode switching simulation training system based on a real CTC system provided by this embodiment includes a center platform and a plurality of student platforms connected to the center platform through a network.

In this embodiment, as shown in FIG. 2, for the convenience of description, a structure of one center and two student platforms (a first student platform and a second student platform) is used for description. In fact, dynamic expansion can be carried out as needed to add multiple student platforms. In the arrangement diagram, each block (such as the center and the first student platform) represents a plurality of servers arranged in a same place, and the specific number of servers to be used depends on the actual situation and is at least one; and there are various systems specifically arranged, such as the teacher platform, the CTC service system, and the center simulation system. The teacher platform and the student platforms serve as operation interfaces for a teacher and students, do not participate in mode switching, and will not be added in the subsequent description process.

The center platform includes a first management module and a first training system connected to the first management module. Each student platform includes a second management module and a second training system connected to the second management module. The first management module is configured to control the start and stop of the first training system, and the second management module is configured to control the start and stop of the second training system, so as to switch a training mode of the multi-mode switching simulation system.

In this embodiment, the first training system includes a first CTC service system, a first CTC dispatch system, and a first simulation system. The second training system includes a second CTC service system, a second CTC dispatch system, a CTC autonomous computer, a CTC train service terminal, and a second simulation system.

In this embodiment, the training mode includes an individual training mode, a mixed individual and joint training mode, and a joint training mode.

In this embodiment, the first simulation system is the same as the second simulation system and includes a trackside simulation system, a train control simulation system, and an interlocking simulation system.

The first management module and the second management module are configured to start and stop corresponding system software. Different software can be started according to the requirement of mode switching, so as to ensure that the center and each student platform operate normally in different modes.

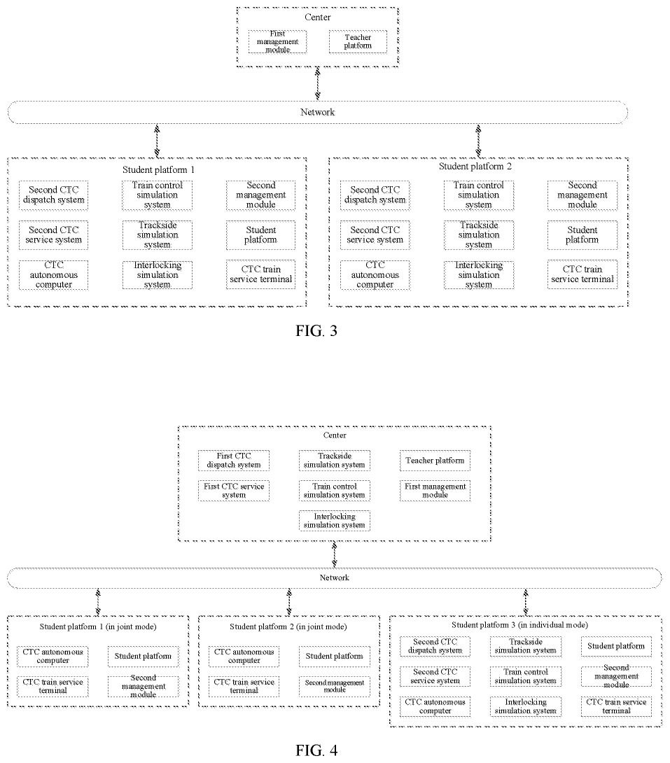

As shown in FIG. 3, when the training mode is the individual training mode, each student platform is in an individual mode; and the first management module in the center platform controls the first training system to stop running, and the teacher computer is started to check a state of the student platform. The second management module in each student platform is configured to start the corresponding second training system based on a preset training requirement.

In this case, each student platform has the ability to independently run the entire simulation training system by itself, and has no service communication with the center and other student platforms, so it is an independent system. Which dispatch consoles and stations run by each student platform can be preset according to the configuration, such that the student can undergo individual practice and training on the corresponding student platform. In addition, it is also possible to configure all the student platforms to run the same dispatch console and station. In this case, training environments on all the student platforms are independent and same, and all students can conduct service practice and scoring on the corresponding student platforms, thereby achieving the purpose of a skills competition. Moreover, the center does not have a capability of training and only has capabilities of management and educational administration statistics.

When the preset training requirement is to train a dispatcher, in view of the training environment for the dispatcher, the second management module in the student platform for training of the dispatcher starts the second CTC dispatch system, the second CTC service system, the CTC autonomous computer, and the second simulation system, and the dispatcher undergoes dispatch training on the corresponding student platform.

When the preset training requirement is to train a station attendant, in view of the training environment for the station attendant, the second management module in the student platform for training of the station attendant starts the second CTC service system, the CTC autonomous computer, the CTC train service terminal, and the second simulation system, and the station attendant undergoes station-related operation and training on the corresponding student platform.

When the preset training requirement is a skills competition for all station attendants, in view of training for the station attendants, the student platforms can be preconfigured with a same station system, and the second management modules of all the student platforms start the second CTC service systems, the CTC autonomous computers, and the CTC train service terminals, such that all the student platforms run a same station environment. In this case, all the students can perform operation based on the same training environment, such that their operations can be scored and evaluated to achieve the purpose of the competition. Therefore, in such mode, each student platform can implement individual practice and training as well as the function of the skills competition.

In summary, when each student platform (a student platform 1 and a student platform 2) runs in the individual mode, the center does not start any training system and only starts the management module and the teacher platform to check the state of each student platform; and the CTC dispatch system, the CTC service system, the CTC autonomous computer, the train service terminal, the train control simulation system, the trackside simulation system, and the interlocking simulation system are started in the student platform. In this way, the complete training system runs inside the student platform, and there is no need for service communication with the center and other student platforms. That is, the student platform is in the individual mode, and the student can perform operation of the dispatcher or the station attendant on the student platform.

As shown in FIG. 4, when the training mode is the mixed individual and joint training mode, some of the plurality of student platforms (a student platform 3) are in the individual mode, while the rest of the student platforms (the student platform 1 and the student platform 2) are in the joint mode; the first management module of the center platform starts the first CTC dispatch system, the first CTC service system, and the first simulation system; the student platforms in the joint mode start the corresponding CTC autonomous computers and CTC train service terminals by their respective second management modules; and the dispatcher and the station attendant call the corresponding first CTC dispatch system, first CTC service system and first simulation system on the center platform by the corresponding student platforms in the joint mode for joint training.

That is, the student platform 1 and the student platform 2 start the CTC autonomous computers and CTC train service terminals to communicate with the service system of the center. The student platforms rely on the same service system of the center. In such a startup environment, the center and the student platforms in the joint mode form a complete “dispatch-station” training environment in service, such that the students can undergo joint training. Due to the fact that the student platforms rely on the same service system of the center, they share the same operating environment and can make service communication, thus achieving the effect of joint training. In this way, the student platform 1, the student platform 2, and the center form a complete joint training system on which the dispatcher and the station attendant can undergo joint training.

The student platforms in the individual mode start the corresponding second CTC dispatch systems, second CTC service systems, CTC autonomous computers, CTC train service terminals, and second simulation systems by their respective second management modules; and the dispatcher and the station attendant undergo individual training by the corresponding student platforms in the individual mode. That is, the individual CTC dispatch system, CTC service system, CTC autonomous computer, CTC train service terminal, trackside simulation system, train control simulation system, and interlocking simulation system are started in the student platform 3. The station system in this student platform communicates with the service system in the student platform to form an individual training system. In this way, the student platform 3 forms a single-mode simulation training system. The student can undergo individual training on this student platform and has no service communication with other training systems (the service system of the center).

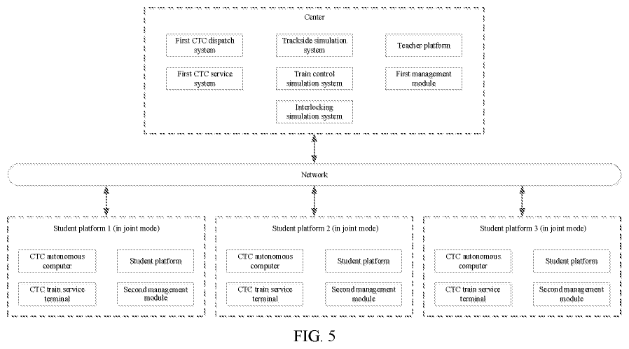

As shown in FIG. 5, when the training mode is the joint training mode, all the student platforms are in a joint mode, and the center and all the student platforms form a complete train service dispatch system. The dispatcher and the station attendant can undergo joint training on train operation management, fault handling, etc. according to actual scenarios. In this case, the center starts the service system (the CTC dispatch system, the CTC service system, the trackside simulation system, the train control simulation system, and the interlocking simulation system).

The first management module in the center platform starts the teacher computer, the first CTC dispatch system, the first CTC service system, and the first simulation system; the second management modules in all the student platforms start the CTC autonomous computers and the CTC train service terminals; and the dispatcher and the station attendant are capable of calling the corresponding first CTC dispatch system, first CTC service system and first simulation system on the center platform from their respective student platforms for joint training.

In summary, when all the student platforms run in the joint mode, all the student platforms only start the station systems (the CTC autonomous computers and the CTC train service terminals) to communicate with the service system of the center so as to jointly form a complete simulation training system on which the dispatcher and the station attendant can undergo joint training.

It can be understood that both the simulation system and the CTC system provided in this embodiment can call existing systems, which are mainly used for corresponding students to learn.

The simulation training system provided by this embodiment can switch among three modes as needed. The dispatcher undergoes practice and training on the student platform of the center, and the attendant undergoes practice and training on the student platform. All the students are not required to gather in a same classroom, that is, there is no need for integration in space, thereby reducing the workload of a training organization, and achieving the purposes of individual contact, joint training, and competition. This method has been tested by an actual training system, can effectively integrate and utilize the equipment, and can simultaneously implement the functions of individual training for dispatchers, individual training for station attendants, joint training for the dispatchers and the attendants, and skills competition.

It should be noted that in this specification, relational terms such as first and second are only used to distinguish one entity or operation from another entity or operation, and do not necessarily require or imply that there is any such actual relationship or order between these entities or operations. Furthermore, the term “comprise/include”, “contain” or any other variant thereof is intended to cover a non-exclusive inclusion, such that a process, method, object or device including a series of elements not only includes those elements, but also includes other elements not explicitly listed, or also includes elements inherent to such process, method, object or device. Without further limitations, an element defined by the phrase “includes one . . . ” does not exclude the presence of additional identical elements in the process, method, object or device including the element.

It should be noted that the apparatuses and methods disclosed in the embodiments of this specification may also be implemented in other ways. The apparatus embodiment described above is only schematic. For example, the flowcharts and block diagrams in the accompanying drawings illustrate the possibly implemented architectures, functions and operations of the apparatus, method, and computer program product according to multiple embodiments of this specification. In this regard, each block in the flowchart or block diagram may represent one module, program segment, or part of code, and the module, program segment, or part of code contains one or more executable instructions for implementing the specified logical functions. It should also be noted that, in some alternative embodiments, the functions marked in the blocks may also occur in an order different from that marked in the accompanying drawings. For example, two continuous blocks may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or actions, or may be implemented by a combination of dedicated hardware and computer instructions.

In addition, all functional modules in each embodiment of this specification may be integrated together to form one independent part, all modules may exist alone, or two or more modules may be integrated to form one independent part.

While the content of the present invention has been described in detail with the above preferred embodiment, it should be recognized that the above description should not be considered as a limitation to the present invention. Various modifications and alternatives to the present invention will become apparent to those skilled in the art upon reading the above content. Therefore, the scope of protection of the present invention should be limited by the appended claims.

1. A multi-mode switching simulation training system based on a real centralized traffic control (CTC) system, comprising:
a center platform and a plurality of student platforms connected to the center platform through a network,
wherein the center platform comprises a first management module and a first training system operatively connected to the first management module;
each of the plurality of student platforms comprises a second management module and a second training system operatively connected to the second management module; and
the first management module is configured to control the start and stop of the first training system, and the second management module is configured to control the start and stop of the second training system, wherein controlling the start and stop of the first training system by the first management module and controlling the start and stop of the second training system by the second management module switches a training mode of the multi-mode switching simulation training system among a plurality of training modes.

2. The multi-mode switching simulation training system based on a real CTC system according to claim 1, wherein;
the first training system comprises a first CTC service system, a first CTC dispatch system, and a first simulation system; and
the second training system comprises a second CTC service system, a second CTC dispatch system, a CTC autonomous computer, a CTC train service terminal, and a second simulation system.

3. The multi-mode switching simulation training system based on a real CTC system according to claim 2, wherein the plurality of training mode-modes comprises an individual training mode, a mixed individual and joint training mode, and a joint training mode.

4. The multi-mode switching simulation training system based on a real CTC system according to claim 3, further comprising:
an educational administration system, wherein the educational administration system comprises a teacher computer disposed in the center platform and a plurality of student computers;
each of the plurality of student computers is disposed in a corresponding one of the plurality of student platforms, and the teacher computer is connected to the plurality of student computers through the network; and
the teacher computer is configured to manage an examination question scenario, send examination questions to a corresponding one of the student computers, and analyze and display an examination result of the examination questions fed back by the corresponding student computer.

5. The multi-mode switching simulation training system based on a real CTC system according to claim 4, wherein the first simulation system is the same as the second simulation system and comprises a trackside simulation system, a train control simulation system, and an interlocking simulation system.

6. The multi-mode switching simulation training system based on a real CTC system according to claim 5, wherein when the training mode is the individual training mode:
each of the plurality of student platforms is in an individual mode;
the first management module in the center platform controls the first training system to stop running, and controls the teacher computer to start running to check a state of each student platform; and
the second management module in each student platform is configured to start the corresponding second training system based on a preset training requirement.

7. The multi-mode switching simulation training system based on a real CTC system according to claim 6, wherein when the preset training requirement is to train a dispatcher, the second management module starts the second CTC dispatch system, the second CTC service system, the CTC autonomous computer, and the second simulation system, and the dispatcher undergoes dispatch training on a corresponding one of the student platforms.

8. The multi-mode switching simulation training system based on a real CTC system according to claim 6, wherein when the preset training requirement is to train a station attendant, the second management module starts the second CTC service system, the CTC autonomous computer, the CTC train service terminal, and the second simulation system, and the station attendant undergoes station-related operation and training on a corresponding one of the student platforms.

9. The multi-mode switching simulation training system based on a real CTC system according to claim 6, wherein when the preset training requirement is a skills competition for all station attendants, the second management modules of all the student platforms start the second CTC service systems, the CTC autonomous computers, and the CTC train service terminals, such that all the student platforms run a same station environment.

10. The multi-mode switching simulation training system based on a real CTC system according to claim 5, wherein when the training mode is the joint training mode:
all the student platforms are in a joint mode;
the first management module in the center platform starts the teacher computer, the first CTC dispatch system, the first CTC service system, and the first simulation system;
the second management modules in all the student platforms start the CTC autonomous computers and the CTC train service terminals; and
the dispatcher and the station attendant are capable of calling the corresponding first CTC dispatch system, first CTC service system and first simulation system on the center platform from their respective student platforms for joint training.

11. The multi-mode switching simulation training system based on a real CTC system according to claim 5, wherein when the training mode is the mixed individual and joint training mode:
some of the plurality of student platforms are in the individual mode, while the rest of the student platforms are in the joint mode;
the first management module of the center platform starts the first CTC dispatch system, the first CTC service system, and the first simulation system;
the student platforms in the joint mode start the corresponding CTC autonomous computers and CTC train service terminals by their respective second management modules;
the dispatcher and the station attendant call the corresponding first CTC dispatch system, first CTC service system and first simulation system on the center platform by the corresponding student platforms in the joint mode for joint training;
the student platforms in the individual mode start the corresponding second CTC dispatch systems, second CTC service systems, CTC autonomous computers, CTC train service terminals, and second simulation systems by their respective second management modules; and
the dispatcher and the station attendant undergo individual training by the corresponding student platforms in the individual mode.
